(19) United States
(12) Patent Application Publication
(10) Pub. No.: US 2009/0056073 A1
(43) Pub. Date: Mar. 5, 2009

(54) HINGE

(75) Inventor: Chung-Yi Lin, Shulin (TW)

Correspondence Address: APEX JURIS, PLLC, 12733 LAKE CITY WAY NORTHEAST, SEATTLE, WA, 98125, US

(73) Assignee: SHIN ZU SHING CO., LTD., Shulin City (TW)

(21) Appl. No.: 11/849,347

(22) Filed: Sep. 3, 2007

(51) Int. Cl. E05D 7/04

(52) U.S. Cl. 16/235

(57) ABSTRACT

A hinge is mounted between a body and a cover of an electronic device and has a bracket, two leaves and two fasteners. The bracket is formed integrally as a single piece and has two barrels formed integrally with each other. The leaves correspond to and are rotatably mounted respectively through the barrels. The fasteners are securely mounted respectively on the leaves and hold the leaves in the corresponding bracket. The hinge allows the cover to pivot on the body 360 degrees.

### BACKGROUND OF THE INVENTION

1. Field of the Invention

The present invention relates to a hinge, and more particularly to a hinge that is mounted between a body and a cover of an electronic device and allows the cover to pivot around the body 360 degrees to allow the electronic device to transform from a closed-and-folded configuration to an opened-and-folded configuration.

2. Description of Related Art

Electronic devices such as laptops, cellular phones and personal data assistants have a body and a cover mounted pivotally on the body using a hinge.

The cover has an inner surface and may comprise a display mounted on the inner surface and may have a touch screen. The base has an inner surface and comprises an input device mounted on the inner surface. The input device may be a keyboard, keypad, track pad or the like. Therefore, both the cover and the base have a thickness that limits a maximum rotation below 360 degrees, frequently to less than 180 degrees.

However, to operate the touch screen or the track pad most comfortably, the cover must be opened to the maximum rotational angle but with the conventional hinge, the covered electronic device opens into an incompletely folded configuration. The incompletely folded configuration incurs difficulty on a user for holding and inputting data into the electronic device.

To overcome the shortcomings, the present invention provides a hinge to mitigate or obviate the aforementioned problems.

### SUMMARY OF THE INVENTION

The main objective of the invention is to provide a hinge that is mounted between a body and a cover of an electronic device and allows the cover to pivot around the body 360 degrees to allow the electronic device to transform from a closed-and-folded configuration to an opened-and-folded configuration.

The hinge in accordance with the present invention is mounted between the body and the cover of the electronic device and comprises a bracket, two leaves and two fasteners. The bracket is formed integrally as a single piece and has two barrels formed integrally with each other. The leaves correspond to and are rotatably mounted respectively through the barrels. The fasteners are securely mounted respectively on the leaves and hold the leaves in the corresponding bracket. The hinge allows the cover to pivot on the body 360 degrees.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a hinge in accordance with the present invention;

FIG. 2 is a partially exploded, front perspective view of the hinge in FIG. 1, shown with a stationary leaf exploded;

FIG. 3 is an exploded perspective view of the hinge in FIG. 1;

FIG. 4 is a partially exploded, rear perspective view of the hinge in FIG. 1, shown with a rotating leaf exploded;

FIG. 5 is a top view of the hinge mounted between the body and the cover of the electronic device, shown open in phantom lines;

FIG. 6 is an operational side view of the electronic device with the hinge in FIG. 1 in a closed-and-folded configuration; and

FIG. 7 is an operational side view of the electronic with the hinge in FIG. 6 in an opened-and-folded configuration.

### DETAILED DESCRIPTION OF THE PREFERRED EMBODIMENT

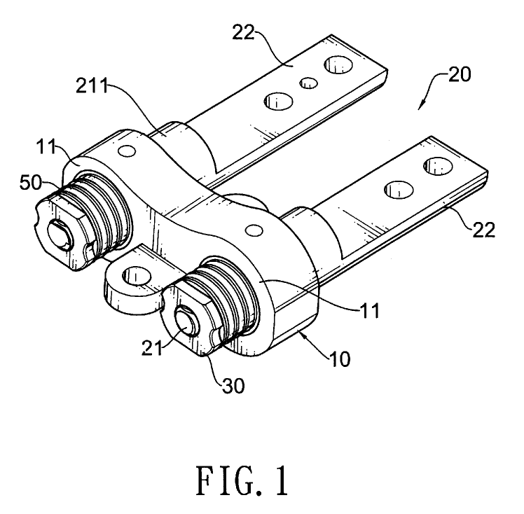

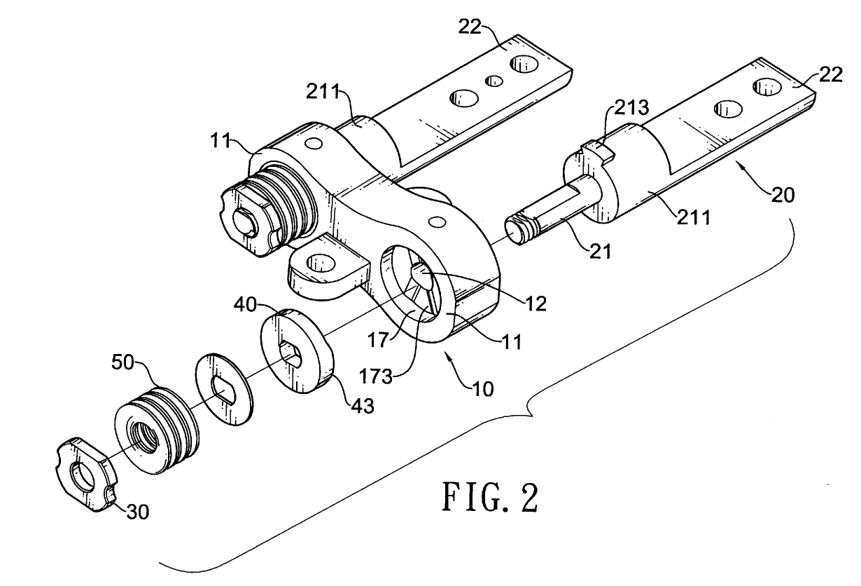

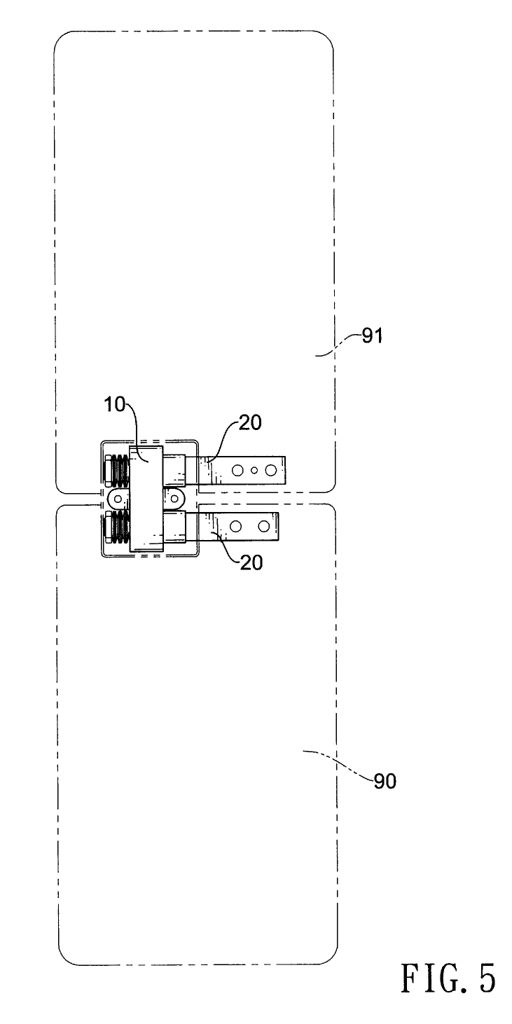

With reference to FIGS. 1, 2 and 5, a hinge in accordance with the present invention is mounted between an electronic device such as cellular phone, a personal data assistant or the like having a body (90), a cover (91) mounted pivotally on the body and an input device being a touch screen mounted on the cover.

The hinge comprises a bracket (10), two leaves (20), two fasteners (30) and may further have two positioning rings (40) and two sets of wave springs (50).

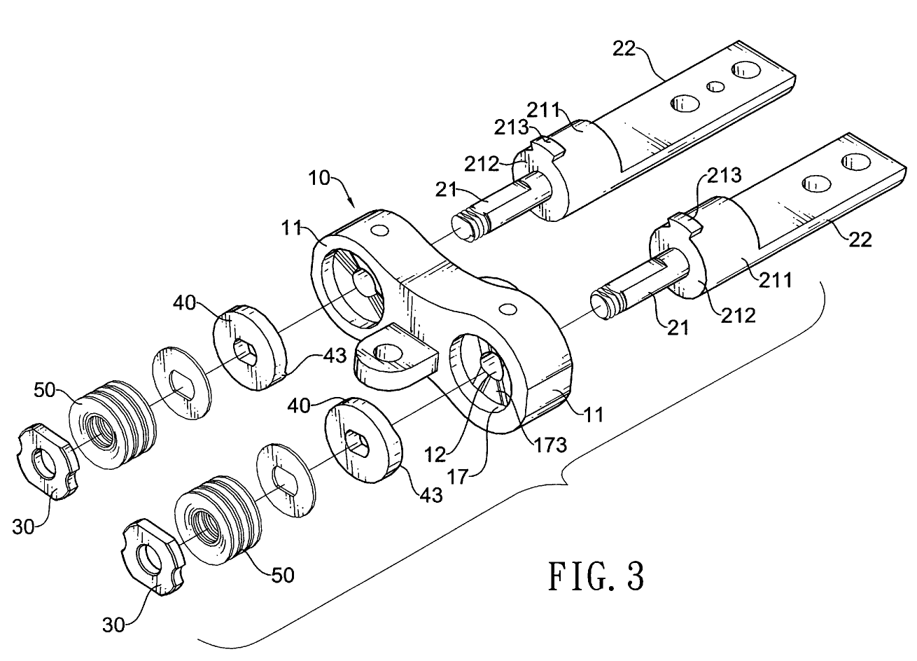

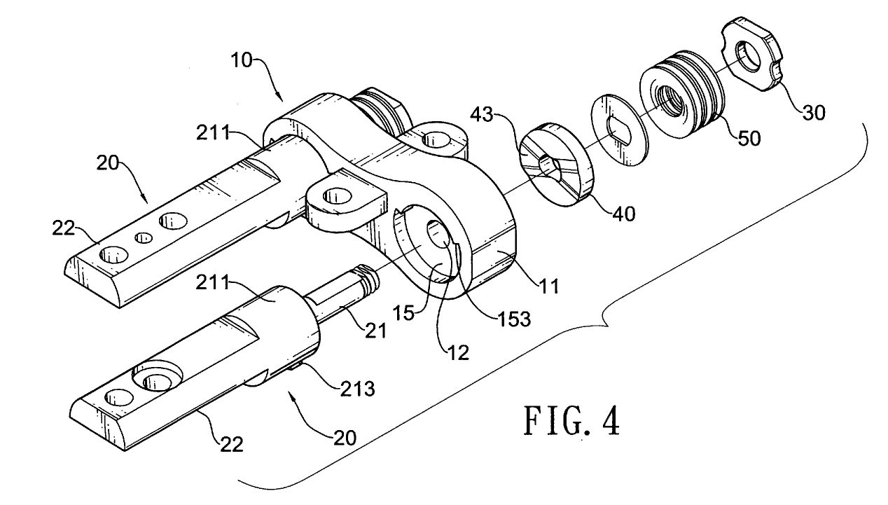

With further reference to FIGS. 3 and 4, the bracket (10) is formed integrally as a single piece, is mounted longitudinally between the cover (91) and the base (90) and has two barrels (11). The barrels (11) are formed integrally with each other, are arranged abreast in a transverse line and each barrel (11) has a rear end, a front end, a mounting hole (12) and may further have a limiting recess (15) and a positioning countersink (17). The mounting hole (12) is defined axially through the barrel (11). The limiting recess (15) is defined longitudinally in the rear end of the barrel (11), communicates with the mounting hole (12) and has an inner surface and a limiting protrusion (153). The limiting protrusion (153) is formed on and protrudes radially inward from the inner surface. The positioning countersink (17) is defined in the front end of the barrel (11), communicates with the mounting hole (12) and has a fastening surface and multiple detents (173). The detents (173) are defined in the fastening surface of the positioning countersink (17) and are arranged in a circle.

The leaves (20) correspond respectively to the barrels (11) of the bracket (10) and are rotatably mounted respectively through the mounting holes (12) in the barrels (11). Each leaf (20) has a pintle (21) and a mounting segment (22).

The pintle (21) is mounted rotatably through the mounting hole (12) of a corresponding barrel (11), has a proximal end and a distal end and may have a non-circular cross section, an outer thread, an annular flange (211) and a limiting protrusion (213). The outer thread is formed on the distal end. The annular flange (211) is formed on and protrudes radially out from the proximal end of the pintle (21) and is mounted rotatably in the limiting recess (15) in the corresponding barrel (11) and has an inner end (212). The inner end (212) of the annular flange (211) abuts the inner surface of the limiting recess (15) to prevent the pintle (21) from inadvertently going through the mounting hole (12). The limiting protrusion (213) is formed on and protrudes radially out from the inner surface of the annular flange (211) and selectively abuts the limiting protrusion (153) of the limiting recess (15) in the corresponding barrel (11) to limit and prevent the leaf (20) from further rotating in the bracket (10). In a preferred embodiment of the hinge, the limiting protrusion (213) of the leaf (20) cooperates with the limiting protrusion (153) of the corresponding barrel (11) to limit the leaf (20) to rotate within 180 degrees.

The mounting segment (22) is formed on and protrudes from the proximal end of the pintle (21), may be adjacent to the annular flange (211) and the mounting segments (22) are mounted respectively in the body (90) and the cover (91).

The fasteners (30) are securely mounted respectively on the distal ends of the pintles (211) of the leaves (20) to hold the leaves (20) in the bracket (10). Each fastener (30) may be a nut having an inner thread engaging with the outer thread of the pintle (21) of one of the leaves (20).

The positioning rings (40) correspond respectively to the barrels (11) of the bracket (10), are slidably mounted respectively around the pintles (21) of the leaves (20) and each positioning ring (40) has an inner end, a through hole and multiple bosses (43).

The through hole is defined through the positioning ring (40), mounted around one of the pintles (21) and may have a non-circular cross section corresponding to the non-circular cross section of the corresponding pintle (21) of each leaf (20) to prevent the positioning ring (40) from rotating around the pintle (21).

The bosses (43) are formed on the inner surface of the positioning ring (40), are arranged in a circle and selectively engage respectively with the detents (173) in the positioning countersink (17) in a corresponding barrel (11) so that the leaves (21) may be held at specific rotational positions on the bracket (10).

The sets of wave springs (50) correspond respectively to the barrels (11), fasteners (30), and the positioning rings (40) and are mounted respectively around the pintles (21) of the leaves (10). Each set of the wave springs (50) is located between a corresponding fastener and a corresponding positioning ring (40) and presses the corresponding positioning ring (40) into the positioning countersink (17) in a corresponding barrel (11).

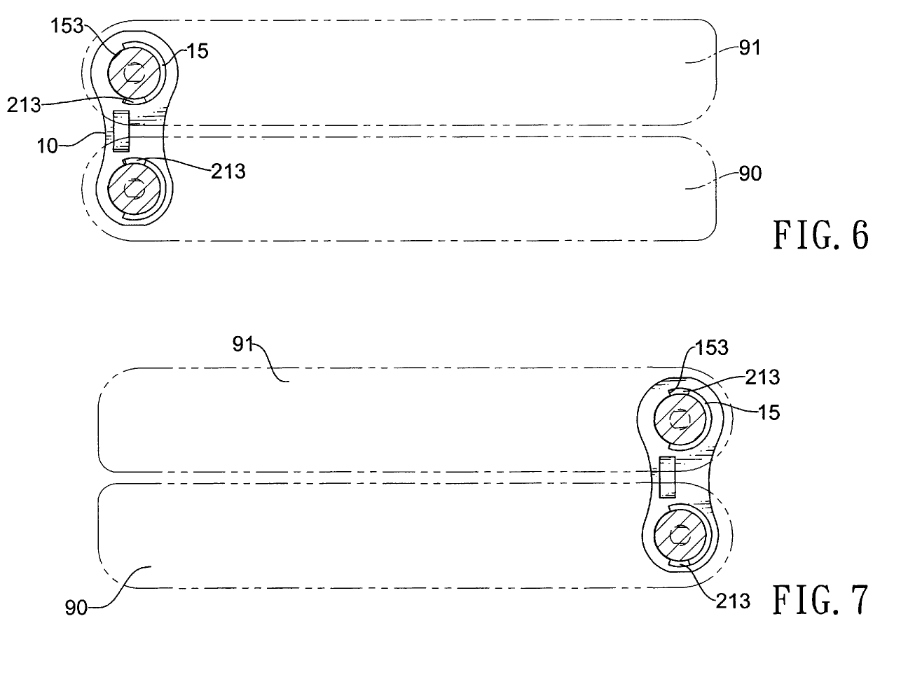

With further reference to FIGS. 6 and 7, the electronic device may therefore be rotated from a closed-and-folded configuration 360 degrees around the body (90) and into an opened-and-folded configuration due to each leaf (20) being capable of rotating 180 degrees on the corresponding barrel (11) of the bracket (10). Therefore, a user may conveniently hold the electronic device in the opened-and-folded configuration and easily input data using the input device.

Furthermore, the bracket (10) formed as the single piece so is firm and compact so that the hinge has a low cost but high durability.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a bracket being formed integrally as a single piece and having two barrels formed integrally with each other, arranged abreast in a transverse line and each barrel having
a rear end;
a front end; and
a mounting hole being defined axially through the barrel;
two leaves corresponding respectively to the barrels of the bracket, being rotatably mounted respectively through the mounting holes in the barrels and each leaf having
a pintle being mounted rotatably through the mounting hole of a corresponding barrel and having a proximal end and a distal end; and
a mounting segment being formed on and protruding from the proximal end of the pintle; and
two fasteners being securely mounted respectively on the distal ends of the pintles of the leaves to hold the leaves in the bracket.

2. The hinge as claimed in claim 1, wherein
each barrel further has a limiting recess defined longitudinally in the rear end of the barrel, communicating with the mounting hole and having
an inner surface; and
a limiting protrusion being formed on and protruding radially inward from the inner surface; and
the pintle of each leaf further has
an annular flange being formed on and protruding radially out from the proximal end of the pintle adjacent to the mounting segment and being mounted rotatably in the limiting recess in the corresponding barrel and having an inner end abutting the inner surface of the limiting recess; and
a limiting protrusion being formed on and protruding radially out from the inner end of the annular flange and selectively abutting the limiting protrusion of the limiting recess in the corresponding barrel.

3. The hinge as claimed in claim 2, wherein
each barrel further has a positioning countersink being defined in the front end of the barrel, communicating with the mounting hole and having
a fastening surface; and
multiple detents being defined in the fastening surface of the positioning countersink; and
the hinge further has two positioning rings corresponding respectively to the barrels of the bracket, being slidably mounted respectively around the pintles of the leaves and each positioning ring having
an inner surface;
a through hole being defined through the positioning ring and mounted around one of the pintle; and
multiple bosses being formed on the inner surface of the positioning ring and selectively engaging the detents in the positioning countersink in a corresponding barrel.

4. The hinge as claimed in claim 3 further comprising two sets of wave springs corresponding respectively to the barrels, fasteners and the positioning rings and mounted respectively around the pintles of the leaves, and each set of the wave springs being located between a corresponding fastener and a corresponding positioning ring and pressing the corresponding positioning ring into the positioning countersink in a corresponding barrel.

5. The hinge as claimed in claim 4, wherein
the pintle of each leaf further has a non-circular cross section; and
the through hole of each positioning ring further has a non-circular cross section corresponding to the non-circular cross section of the pintle of each leaf.

6. The hinge as claimed in claim 5, wherein
the pintle of each leaf further has an outer thread being formed on the distal end of the pintle; and
each fastener is a nut having an inner thread engaging with the outer thread of the pintle of one of the leaves.

7. The hinge as claimed in claim 2, wherein the limiting protrusion of each leaf cooperates with the limiting protrusion of the corresponding barrel to limit the leaf to rotate within 180 degrees.

8. The hinge as claimed in claim 6, wherein the limiting protrusion of each leaf cooperates with the limiting protrusion of the corresponding barrel to limit the leaf to rotate within 180 degrees.
